(19) United States
(12) Patent Application Publication
(10) Pub. No.: US 2023/0195586 A1
(43) Pub. Date: Jun. 22, 2023

(54) DIAGNOSTIC TESTS FOR COMPUTING DEVICES

(71) Applicant: Hewlett-Packard Development Company, L.P., Spring, TX (US)

(72) Inventors: SARIN SUSEELAN BHARGAVI, Bangalore (IN); SOMASHEKARA NANJUNDA REDDY, Bangalore (IN)

(73) Assignee: Hewlett-Packard Development Company, L.P., Spring, TX (US)

(21) Appl. No.: 17/912,609

(22) PCT Filed: Dec. 9, 2020
(86) PCT No.: PCT/US2020/070882

§ 371 Date: Sep. 19, 2022

(30) Foreign Application Priority Data
Apr. 9, 2020 (IN) 202041015639

(51) Int. Cl. G06F 11/273; G06F 11/22

(52) U.S. Cl. CPC G06F 11/2733; G06F 11/2273

(57) ABSTRACT

Examples for servicing a computing device by a servicing agent are described. In an example, the servicing agent receives a first set of information which includes device information corresponding to the computing device. Further, the servicing agent receives a second set of information during a second session, wherein the second set of information is received through a user input and is indicative of a state of the computing device. The servicing agent further processes the first set of information and the second set of information to determine a diagnostic test. The servicing agent causes to execute the diagnostic test on the computing device.

### BACKGROUND

A computing device is an electronic device comprising a processor. Such a computing device may be adapted to perform either a specific function or multiple functions. Examples of such computing device include, but is not limited to, personal computers, image reproduction devices, such as printers and photocopiers, audio and visual equipment, such as cameras, video recorders and cell phones. During use, the computing device may face certain issues, and hence, may require servicing or troubleshooting to restore the computing device to its previous operational state. The servicing or troubleshooting may be performed by a user of the computing device, who in turn may be guided through a servicing process by a customer representative or through an automated system.

### BRIEF DESCRIPTION OF DRAWINGS

The following detailed description references the drawings, wherein:

FIG. 1 illustrates a system for determining a diagnostic test for servicing a computing device, as per an example;

FIG. 2 illustrates a networked environment comprising a system for determining a diagnostic test for servicing a computing device, as per an example;

FIG. 3 illustrates a method for determining a diagnostic test for servicing a computing device, as per an example;

FIG. 4 illustrates a method for determining a diagnostic test for servicing a computing device, as per another example; and

FIG. 5 illustrates a computing environment implementing a non-transitory computer-readable medium for determining a diagnostic test for servicing a computing device, as per an example.

### DETAILED DESCRIPTION

As may be generally understood, servicing of a computing device is performed when the computing device faces an operational issue, and thus deviates from its normal operation. In certain cases, the computing device may malfunction during operation. It may be noted that the issues may arise due to either software or hardware of the computing device. Such issues may be resolved through intervention by a technical personnel. Such an intervention may be performed through servicing (as a preventive measure), or through a process which is commonly referred to as troubleshooting. Servicing or troubleshooting may be performed by a user or a customer support representative to identify a problem and address it to make the computing device operational again.

Generally, servicing (or troubleshooting) support for a computing device is initiated by a user of the computing device. The user may contact a customer support representative either by way of a voice call or through any electronic communication, for example, chat and message. During such an interaction, the user may provide certain information pertaining to the computing device to be serviced. Based on the received information, the customer support representative may provide a series of options that may be employed by the user for servicing or resolving any issue affecting the computing device. The servicing may be undertaken for either rectifying a technical issue faced by the computing device or performing certain operations (such as installing updates, factory reset, installing patches, etc.) to enable the computing device to operate in an intended manner. It may be noted that the function of the customer support representative may be implemented by an individual or a software-based servicing agent. In case of the latter, the servicing agent may process the information based on certain predefined rules to provide the options which may be performed by the user of the computing device.

In certain cases, the information provided by the user may be inadequate. This may be either due to lack of technical expertise, or any other reason. In such cases, problem resolution may take time, since the customer support representative may not be completely appraised of the condition of the computing device which is to be serviced. In cases where the customer support function is enabled through a software-based servicing agent, the inputs (which are typically provided in a colloquial manner using natural language-based inputs) may not be sufficient for the servicing agent to process in order to determine the appropriate options that need to be provided to the user. The servicing agents may end up providing inconsistent results since slight variations in the inputs provided by the user may yield differing options being provided by the servicing agent. Furthermore, the servicing agent may also not have any access to the computing device attributes, which may be useful in determining the issue and providing appropriate options for resolving the issue. As a result, the accuracy of the options for resolving the issue may not be adequate to address the issue which the computing device is facing.

Approaches for servicing a computing device, are described. It may be noted that the term ‘servicing’ has been used in the context of undertaking certain actions for preventive purposes (e.g., installing updates) or for resolving an operational issue being faced by the computing device (e.g., troubleshooting). The servicing may be performed based on suggestive actions or the diagnostic test that may be provided by a software-based servicing agent in response to an information pertaining to the computing device to be serviced and based on inputs provided by the user of the computing device. The servicing agent may be implemented through executable instructions within a remote server, which in turn may be communicatively coupled to the computing device to be serviced. It may be noted that the computing device may be any processor-based device which may be programmed to perform a variety of functions. Examples of such a computing device include, but are not limited to, a personal computer, laptop, portable computing devices (such as tablets, notebook computers), multi-function devices (such as printers, scanners).

In operation, a first session may be initially established between the computing device and the servicing agent. Once the communication between the computing device and the servicing agent is established, a device information corresponding to the computing device is obtained and communicated to the servicing agent. In an example, such device information may include configuration information or information pertaining to certain settings of the computing device. Thereafter, the servicing agent may establish a second session with the user of the computing device to be serviced. The second session, in an example, maybe either through a voice call or any other mechanisms which allow the user to interact with the servicing agent in real-time. The servicing agent may link the first session with the second session.

With the linking of the first session and the second session, the servicing agent may seek information from the user, as well as the computing device. In cases where the second session is via a voice call, the servicing agent may obtain information concerning the computing device based on verbal inputs from the user. The information received from the user during the second session may then be processed along with the information retrieved over the first session. Based on the processing, the servicing agent may determine a diagnostic test for the computing device to be serviced. It may be noted that the diagnostic test corresponds to the issue which is being faced by the computing device. In an example, the diagnostic test may be utilized to derive values of device attributes, which in turn, may be determined based on the first and the second set of information. A diagnostic test may be considered as a single instruction or a combination of instructions, which when executed may derive values of device attributes in the form of diagnostic information. The diagnostic information may include information pertaining to the state of the computing device.

Once obtained, the diagnostic information, the device information and the information from the user may be subsequently processed to determine how the servicing of the computing device is to be performed. To such an end, the servicing may be performed based on a servicing operation. As mentioned previously, the servicing operation may be for preventive measures, such as installing a patch or an update, or performing a factory reset. The servicing operation may also be performed for rectifying or resolving an issue being faced by the computing device. Considering that the servicing operation for servicing the computing device is based on the device information, information received from the user of the computing device and the diagnostic information, the servicing operation thus determined is accurate and pertinent to the servicing of the computing device.

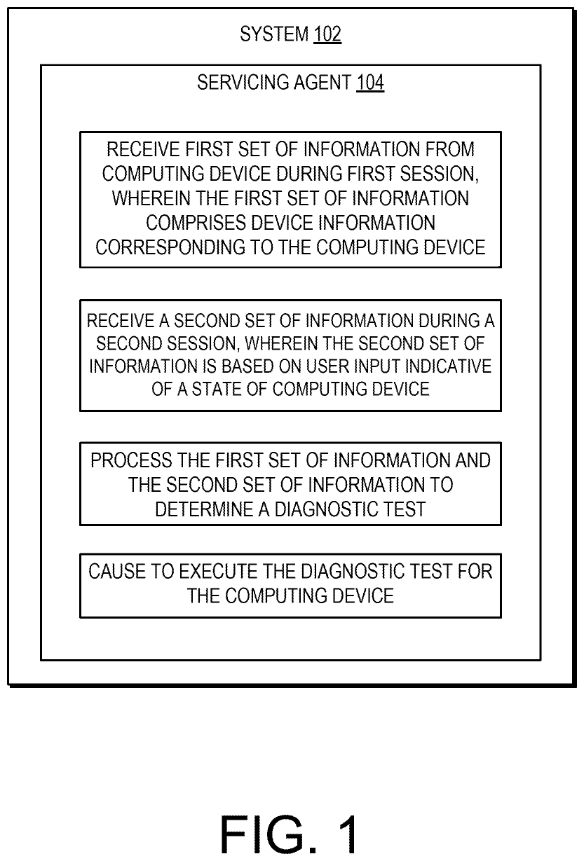

FIG. 1 illustrates a servicing system 102 for servicing a computing device, as per an example. The servicing system 102 (referred to as the system 102 in FIG. 1) may be any processor enabled device which performs certain specific functions. The system 102 may be further in communication with a computing device (not depicted in FIG. 1). An example of the system 102 includes, but is not limited to, a remote server. The system 102 may be either a standalone device or in communication with other systems (not shown in FIG. 1) over a communication network. The present approaches may also be implemented in other types of the system 102 without deviating from the scope of the present subject matter.

In the example as illustrated, the system 102 may further include a servicing agent 104, which provides servicing operations for servicing a computing device. In an example, the servicing agent 104 executes computer-readable instructions to perform operations which then may provide servicing operations for servicing the computing device.

Continuing with the present example, the servicing agent 104 receives a first set of information from the computing device to be serviced, during a first session. In an example, the first session may be established when a user of the computing device initiates a request for servicing or for resolving an operational issue faced by the computing device. As the first session is initiated, the first set of information pertaining to the computing device is obtained and transmitted to the servicing agent 104 of the system 102. In an example, the first set of information may include device information corresponding to the computing device. For example, the first set of information may indicate any critical system error which the computing device may have faced, configuration information concerning the computing device or information pertaining to certain settings of the computing device. Thereafter, the servicing agent 104 may establish a second session with the user of the computing device. In an example, the second session is established over a communication platform that differs from the communication platform over which the first session was established.

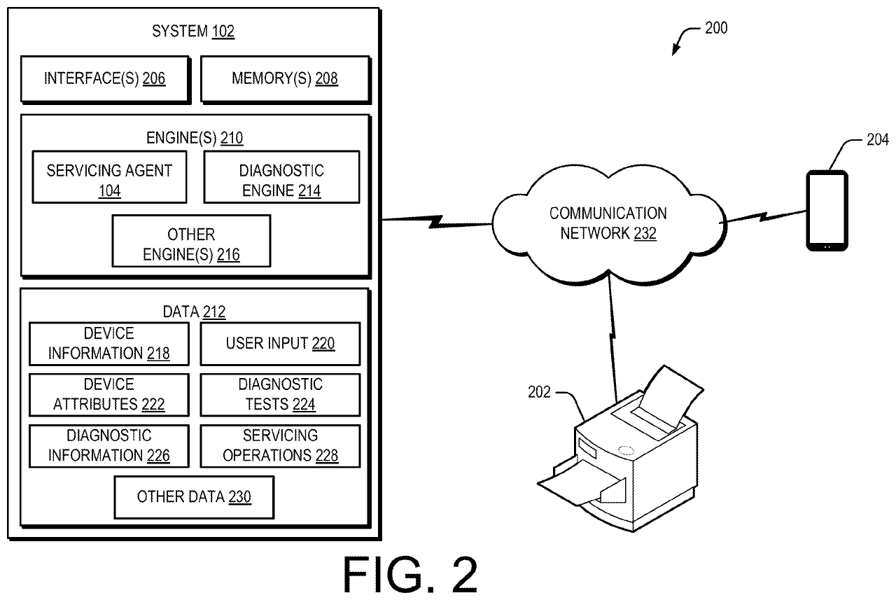

Over the second session, the servicing agent 104 may receive a second set of information through a user input provided by the user of the computing device. The input may be indicative of a state of the computing device which is to be serviced. The servicing agent 104 may thereafter process the first set and the second set of information to determine a diagnostic test for the computing device to be serviced. Once the diagnostic test is determined, the servicing agent 104 may cause the diagnostic test to be executed. The execution of the diagnostic test may derive diagnostic information pertinent to the computing device. In an example, based on the first set and the second set of information, and the diagnostic information, the servicing agent 104 may generate servicing operations that may be performed for servicing the computing device. The manner in which the servicing agent 104 is to interface with the computing device is further explained in detail in conjunction with FIG. 2.

FIG. 2 illustrates a networked environment 200 comprising a system 102 which is adapted to establish a communication session with a computing device 202 which is to be serviced. The system 102 is further adapted to establish a communication session with a user device 204. It may be noted that the user device 204 may be a device that is accessible to, or which may belong to the user (not shown in FIG. 2) of the computing device 202. Although FIG. 2 depicts the computing device 202 as a print device, the same should not be construed as a limitation. Other examples of the computing device 202 for which the present approaches may be implemented are also possible without limiting the scope of the present subject matter in any manner. Examples of such computing device 202 include, but are not limited to, a print device, an imaging device, or other electronic devices, such as desktop computers, laptop computers, notebook computers, tablet, scanner, set-top box, and smart televisions.

Returning to the present example, the system 102 further includes interface(s) 206, memory(s) 208, engine(s) 210 and data 212. The interface(s) 206 may include a variety of software and hardware interfaces that allow the system 102 to interact with other devices, such as the computing device 202 and the user device 204, in addition to other devices such as network entities, web servers, and external repositories, and peripheral devices such as input/output (I/O) devices (not shown in FIG. 2 for sake of brevity). The memory(s) 208 may include any computer-readable medium known in the art including, for example, volatile memory, such as Static Random-Access Memory (SRAM) and Dynamic Random-Access Memory (DRAM), and/or non-volatile memory, such as Read-Only Memory (ROM), Erasable Programmable ROMs (EPROMs), flash memories, hard disks, optical disks, and magnetic tapes.

The system 102 further includes engine(s) 210. The engine(s) 210 may be implemented as a combination of hardware and programming, for example, programmable instructions to implement a variety of functionalities of the engine(s) 210. In examples described herein, such combinations of hardware and programming may be implemented in several different ways. For example, the programming for the engine(s) 210 may be executable instructions. Such instructions may be stored on a non-transitory machine-readable storage medium which may be coupled either directly with the system 102 or indirectly (for example, through networked means). In an example, the engine(s) 210 may include a processing resource, for example, either a single processor or a combination of multiple processors, to execute such instructions. In the present examples, the non-transitory machine -readable storage medium may store instructions that, when executed by the processing resource, implement engine(s) 210. In other examples, the engine(s) 210 may be implemented as electronic circuitry.

The engine(s) 210 include the servicing agent 104, diagnostic engine 214, and other engine(s) 216. The other engine(s) 216 may further implement functionalities that supplement applications or functions performed by the system 102 or any of the engine(s) 210. The data 212, on the other hand, includes data that is either stored or generated as a result of functionalities implemented by any of the engine(s) 210 or the system 102. It may be further noted that information stored and available in the data 212 may be utilized by the engine(s) 210 for servicing the computing device 202. The data 212 may include device information 218, user input 220, device attributes 222, diagnostic tests 224, diagnostic information 226, servicing operation 228 and other data 230. The device information 218 may further include information pertaining to the computing device 202. Examples of device information 218 include device identifiers, configuration information concerning the computing device, information pertaining to certain settings of the computing device, information pertaining to device errors that the computing device 202 may have faced, information pertaining to the version of software installed, and such. It may be noted that such examples are only indicative. The present approaches may be applicable to other examples without deviating from the scope of the present subject matter.

The device information 218 may constitute first set of information received by the servicing agent 104 from the computing device 202. Moreover, the user input 220 may be provided as a second set of information, by a user of the computing device 202, via the user device 204. The other data 230 may include information, for example, associated with the operation of the system 102.

Within the networked environment 200, the system 102 is in communication with the computing device 202 and the user device 204 over the communication network 232. The communication network 232 may be a single communication network or a combination of multiple communication networks and may use a variety of different communication protocols. The communication network 232 may be a wireless network, a wired network, or a combination thereof. Examples of such individual communication networks include, but are not limited to, Global System for Mobile Communication (GSM) network, Universal Mobile Telecommunications System (UMTS) network, Personal Communications Service (PCS) network, Time Division Multiple Access (TDMA) network, Code Division Multiple Access (CDMA) network, Next Generation Network (NON), Public Switched Telephone Network (PSTN). Depending on the technology, the communication network 232 includes various network entities, such as gateways, routers; however, such details have been omitted for the sake of brevity of the present description. As also mentioned previously, the computing device 202 and the user device 204 may both correspond to a user (not shown in FIG. 2), who in turn may be using the computing device 202.

In operation, the user may determine that the computing device 202 may have to be serviced. As may be understood, servicing may involve performing certain operations or actions for preventive purposes, such as installing updates. In certain cases, such operations or actions may be undertaken for resolving or troubleshooting an operational issue that may be faced by the computing device 202. In such a case, the user may initiate a servicing request for performing a servicing operation. In an example, the servicing request may be initiated by the user through the computing device 202 (which is being used by the user). To such an end, the computing device 202 may be provided with a user interface. The user interface may be rendered either onto a panel integrated with the computing device 202, or maybe rendered onto a display device (not shown in FIG. 2) which is coupled to the computing device 202. The user may interact through the user interface to initiate the servicing request for the computing device 202.

In an example, the servicing request may be transmitted to the servicing agent 104 and may further include certain authentication parameters corresponding to the computing device 202. Based on the servicing request and the authentication parameters received from the computing device 202, the servicing agent 104 may authenticate the servicing request from the computing device 202 and may proceed to establish a first session with the computing device 202.

Once the first session is established, the computing device 202 may transmit its pertinent information to the system 102. On receiving the information from the computing device 202, the servicing agent 104 may store the information as device information 218 that constitute the first set of information. In an example, the servicing agent 104 may process the device information 218 to ascertain the servicing operation that has been requested. In case the appropriate servicing operation is determined based on the device information 218, the same may be provided for servicing the computing device 202.

In an example, the servicing agent 104 may provide a set of intermediate operations in response to the device information 218 received from the computing device 202. In such a case, the servicing agent 104 may initially identify an issue based on the device information 218 and accordingly, an appropriate set of intermediate operations may be displayed on the user interface of the computing device 202. The user may be prompted to select any of the provided intermediate operations to resolve the identified issue of the computing device 202. For example, the servicing agent 104 may further receive an input indicating any change in state of the computing device 202 based on implementation of the set of intermediate operations. Such change in state may cause resolution of operational issue faced by the computing device 202.

However, in certain cases the device information 218 and provided set of intermediate operations may not be sufficient for providing the appropriate servicing operation for the computing device 202. In such cases, the servicing agent 104 may initiate a second session with the user of the computing device 202. In this regard, the servicing agent 104 may further generate a first session identifier for the first session and the computing device 202. Such first session identifier may have an associated active time duration, during which the second session may be initiated. In an example, communication resource, such as bandwidth for voice call, or such communication channel may be allocated for communication with the user during the second session. The second session may be established with the user through the user device 204. It may be noted that the second session may be established over a communication platform which is different from the communication platform over which the first session was established. In an example, the request for establishing the second session may be based on a first session identifier corresponding to the first session. Once the second session is established, the servicing agent 104 may associate or link the first session with the second session based on an identifier of the computing device 202, the first session identifier and a second session identifier. In this manner, the servicing agent 104 is in communication with the computing device 202 as well as the user (i.e., through the user device 204).

During the second session, the user may provide a series of inputs in relation to the servicing which is to be performed, or in relation to the state of the computing device 202 which is to be serviced. The inputs, in certain circumstances, may be based on an operational issue that may be faced by the computing device 202. The type of input may vary depending on the mode of communication being utilized by the user. For example, if the second session involves a voice call, the user inputs may include voice-based inputs. Similarly, if the second session involves communication relying on text-based messages being provided through the user device 204 to the servicing agent 104, the appropriate user inputs would be text-based. It may be noted that any other form of user inputs may also be utilized without limiting the scope of the present subject matter. It may be noted that the user inputs provided by the user would include certain descriptors related to the issue which is being faced by the computing device 202. Since the user inputs are provided by the user of the computing device 202, such inputs may be in the form of natural language based inputs and may indicate an operational state of the computing device 202. For example, the user during a voice call session established with the servicing agent 104, may state that the print device (i.e., the computing device 202) is not printing properly.

As the user inputs are received by the system 102, the servicing agent 104 may process and save the same as the user input 220. The servicing agent 104 may subsequently process the user input 220 to determine the intent behind the user input 220 provided by the user, through the user device 204. It may be noted that the intent may be an indication pertaining to one of an operating state of the computing device 202, an operational issue being faced by the computing device 202, or the like. In an example, the intent of the user input 220 may be determined based on a predetermined criteria. The predetermined criteria may be implemented through certain predefined rules. For example, based on the user input 220 and the predefined rules, the servicing agent 104 may determine the intent of the user input 220.

In another example, the user input 220 may be processed by a machine-learning (ML) engine to determine the intent, for example, to identify an operational issue being faced by the computing device 202. In an example, the machine-learning engine may be implemented through other engine(s) 216 within the system 102. In such a case, the user input 220 may be processed by the machine-learning engine to determine the intent pertaining to the user input 220. In another example, the machine-learning engine may be trained based on historically sourced samples of user inputs. Once the machine-learning engine is trained, it may be implemented within the system 102 for determining the intent based on the user input 220.

The intent of the user input 220 and the device information 218 may be further processed to determine device attributes 222 pertaining to the computing device 202. In an example, the device attributes 222 may include operational parameters that otherwise may not have been captured within the device information 218 and the user input 220. For example, in the context of a print device, the device attributes 222 may include toner level, drum condition, fuser condition, counts of the page printed, and the like.

Once the appropriate device attributes 222 are identified, the diagnostic engine 214 proceeds and determines corresponding diagnostic tests 224. As may be understood, the diagnostic engine 214 selects the appropriate diagnostic tests 224 corresponding to the device attributes 222. In an example, the diagnostic tests 224 may be selected based on certain predefined rules. Once the diagnostic tests 224 is selected, the same may be executed by the diagnostic engine 214 on the computing device 202. Execution of the diagnostic tests 224 derives the values of the device attributes 222. For example, in the context of a print device, the diagnostic tests 224 may provide a value depicting the toner levels, page counts, etc. In an example, the values of the device attributes 222 may be stored as diagnostic information 226. The diagnostic information 226 may then be further processed by the servicing agent 104 to identify a servicing operation 228 that is to be performed. In an example, the servicing operation 228 may be determined based on a mapping between the diagnostic information 226 and the servicing operation 228. The servicing operation 228 may include a series of corrective operations that may be performed by the user for servicing the computing device 202. In an example, the servicing operation 228 may also include invoking an external platform, such as for placing an order for the computing device 202, for logging a ticket which will enable a visit from technical personnel, say for resolving the operational issue faced by the computing device 202. In an example, the servicing operation 228 may either be executed manually by the user or maybe enabled through the execution of predefined executable code.

In an example, the diagnostic tests 224 may be determined intermittently during the second session. Such intermittent determination of diagnostic tests 224 enables the system 102 to further determine any additional device attributes 222 that may be instrumental for determining an issue with the computing device 202. For example, on determining a first set of tests from the diagnostic tests 224, the diagnostic engine 214 may determine a first set of diagnostic information. Subsequently, the servicing agent 104 may engage with the user with additional questions or queries. In an example, additional questions or queries may be provided as voice-based or text-based replies to the user device 204. The user on receiving the additional questions or queries through the user device 204 may provide further inputs. The further inputs may subsequently be processed by the machine-learning engine to determine the intent. Based on the intent and the device information 218, the diagnostic engine 214 may identify a second or subsequent set of diagnostic tests. These steps may be performed intermittently to exhaustively determine as many device attributes 222 and diagnostic tests 224 in order to ascertain the issue, and therefore, the servicing operation to resolve the ascertained issue. In the context of the example where the computing device 202 is a print device, the servicing agent 104 may suggest installing the latest set of device drivers, replace the toner, or perform such other steps which may result in resuming the operation of the print device.

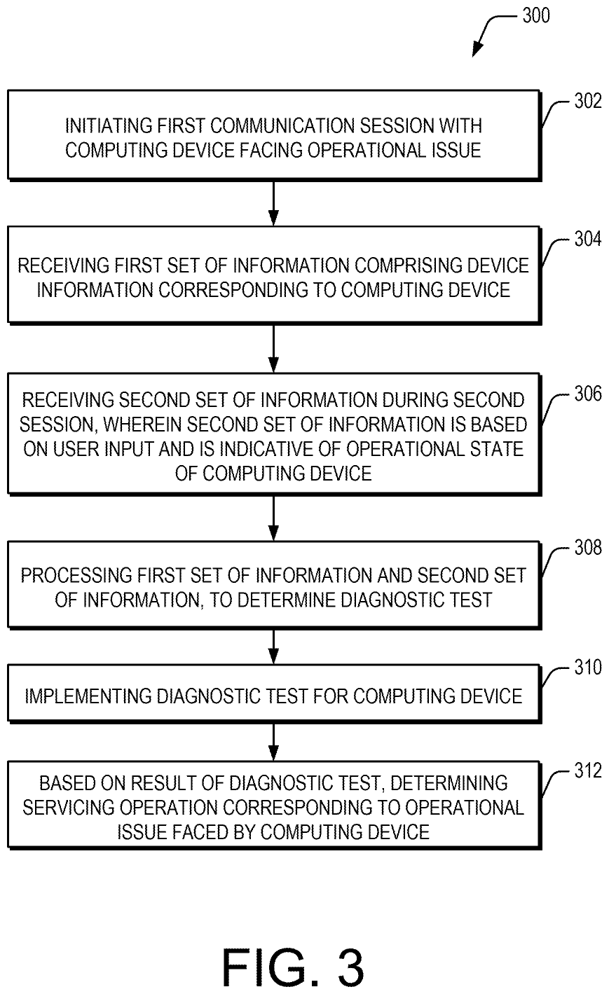

FIG. 3 illustrates a method 300 performed by a servicing agent 104 to service a computing device 202, as per an example. Although the method 300 may be implemented for servicing of a variety of computing devices, for the ease of explanation, the present description of the example method 300 is provided in reference to the above-described computing device 202. The order in which the method 300 is described is not intended to be construed as a limitation, and any number of the described method blocks may be combined in any order to implement the method 300, or an alternative method.

It may be understood that blocks of the method 300 may be executed based on instructions stored in a non-transitory computer-readable medium, as will be readily understood. The non-transitory computer-readable medium may include, for example, digital memories, magnetic storage media, such as magnetic disks and magnetic tapes, hard drives, or optically readable digital data storage media.

Referring to FIG. 3, at block 302, a first session is initiated with the computing device 202 facing an operational issue. For example, a user of the computing device 202 may initiate a servicing request for performing a servicing operation 228. In an example, the servicing request may be initiated by the user through the computing device 202 itself. To such an end, the user may engage with a user interface rendered either onto a panel integrated with the computing device 202, or maybe rendered onto a display device which is coupled to the computing device 202. In response to the initiation request, the servicing agent 104 may initiate a first session with the computing device 202.

At block 304, a first set of information comprising device information corresponding to the computing device is received. For example, once the first session is established, the servicing agent 104 of the system 102 may receive device related information from the computing device 202. The device related information is then stored within the system 102 as the device information 218. In certain instances, the servicing agent 104 may determine the issue faced by the computing device 202 based on the device information 218.

At block 306, a second set of information during a second session is received. The second set of information may be based on a user input and is indicative of an operational state of the computing device 202. As may be noted, in certain instances, it may not be possible to determine the operational issue faced by the computing device 202 based on the first set of information. In such cases, the servicing agent 104 may initiate a second session with the user of the computing device 202, through a user device such as the user device 204. During the second session, the user through the user device 204 may provide a series of inputs describing the operational issue faced by the computing device 202. The user inputs provided by the user would include certain descriptors related to the issue which is being faced by the computing device 202. In an example, the inputs from the user device 204 may be saved as user input 220 within the system 102.

At block 308, the first set of information and the second set of information may be processed to determine diagnostic test. For example, the servicing agent 104 may process the first set of information (e.g., the device information 218) and the second set of information (e.g., the user input 220) to identify the diagnostic tests 224. In an example, the servicing agent 104 may initially determine an intent based on the user input 220. The intent and the device information 218 may be further analyzed to determine device attributes 222 pertaining to the computing device 202. Based on the device attributes 222, the diagnostic engine 214 may identify appropriate diagnostic tests 224.

At block 310, the diagnostic test for the computing device is implemented. For example, the diagnostic engine 214 may execute the diagnostic tests 224 on the computing device 202. Once the diagnostic tests 224 are executed, the diagnostic engine 214 derives the values of the device attributes 222. In an example, the values of the device attributes 222 may be stored as diagnostic information 226.

At block 312, based on a result of the diagnostic test, a servicing operation corresponding to the operational issue faced by the computing device 202 may be determined. For example, the diagnostic engine 214 may execute the diagnostic tests 224 to obtain diagnostic information 226. Based on the diagnostic information 226 thus obtained, the servicing agent 104 may determine the servicing operation 228 that is to be performed for resolving the operational issue faced by the computing device 202. The servicing operation 228 may include a series of corrective operations that may be performed by the user for servicing the computing device 202. In an example, the servicing operations 228 may either be executed manually or maybe enabled through the execution of predefined executable code.

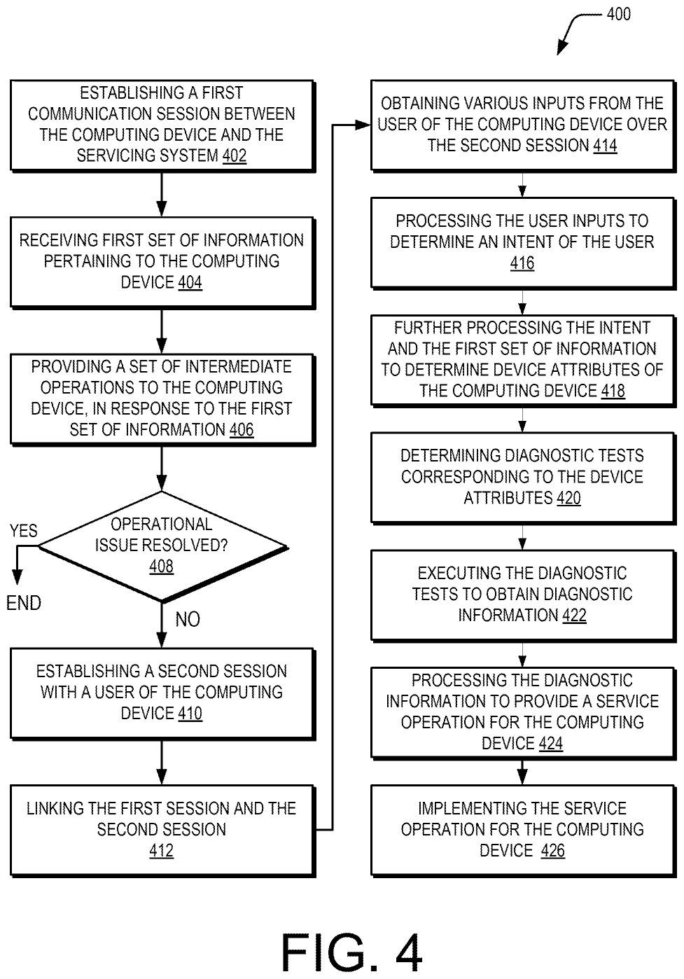

FIG. 4 illustrates another example method 400 performed by the servicing agent 104 to service the computing device 202. At block 402, a first communication session is established between the computing device 202 to be serviced and the servicing system 102. For example, a user of the computing device 202 may initiate a servicing request for performing a servicing operation 228. The servicing request may be initiated by the user through the computing device 202. In an example, the user may access a user interface rendered by the computing device 202. The user interface may be rendered either onto a panel integrated with the computing device 202, or maybe rendered onto a display device which is coupled to the computing device 202. The user may interact through the user interface to initiate the servicing request for the system 102. Based on the request received from the computing device 202, the servicing agent 104 establishes the first session with the computing device 202.

At block 404, first set of information pertaining to the computing device 202 is received. For example, the servicing agent 104 of the system 102 may obtain the first set of information comprising device information 218, which is transmitted by the computing device 202. The device information 218 may include information corresponding to the computing device 202. Examples of such device information 218 may further include but is not limited to, device identifiers, configuration information concerning the computing device, information pertaining to certain settings of the computing device, software version information, information pertaining to any operational errors that the computing device 202 may have faced, and the like.

At block 406, a set of intermediate operations is provided to the computing device 202, in response to the first set of information (referred to as the device information 218). For example, the servicing agent 104 may provide a set of intermediate operations in response to the device information 218 received from the computing device 202. Based on the device information 218, the servicing agent 104 may initially attempt to identify an issue. The appropriate option may be provided and accordingly appropriate set of intermediate operations may be displayed on the user interface of the computing device 202. The user may be prompted to select any of the provided set of intermediate operations to resolve the identified issue of the computing device 202.

At block 408, a determination may be made to ascertain whether the operational issue being faced by the computing device 202 has been resolved through the set of intermediate operations. If it is determined that the operational issue stood was resolved owing to the set of intermediate operations (‘Yes’ path from block 408), the computing device 202 may be considered as free from the operational issue, and the present procedure may end.

In case the operational issue could not be resolved based on the set of intermediate operations (‘No’ path from block 408), the method 400 may proceed further where a second session with the user of the computing device 202 may be established (block 410). In an example, the second session may be established with the user through the user device 204. The second session may be established based on a first session identifier corresponding to the first session.

At block 412, the first session and the second session are linked with each other. For example, the servicing agent 104 may associate the first session with the second session based on an identifier corresponding to the computing device 202.

At block 414, various inputs from the user of the computing device 202 are obtained over the second session. For example, the servicing agent 104 may receive the inputs provided by the user through the user device 204. The inputs provided by the user may correspond to the servicing which is to be performed and may describe an operational issue that may be faced by the computing device 202. The inputs received through the user device 204 may be stored within the system 102 as user input 220. The user input 220 may be in the form of either voice-based inputs or text-based inputs.

At block 416, the user inputs may be further processed to determine an intent of the user. For example, the servicing agent 104 processes the user input 220 to determine the intent of the user. The intent may be considered as an indication pertaining to an operating state of the computing device 202, an operational issue being faced by the computing device 202, or the like. In an example, the servicing agent 104 may process the user input 220 based on predetermined criteria to determine the intent. The predetermined criteria may be implemented through either certain predefined rules or a machine-learning engine implemented within the system 102. It may be noted that other approaches for determining the intent based on the user input 220 may also be employed without deviating from the scope of the present subject matter.

At block 418, the intent and the first set of information may be processed to determine device attributes corresponding to the computing device 202 to be serviced. For example, the servicing agent 104 may process the intent of the user input 220 and the device information 218 to determine device attributes 222 of the computing device 202. The device attributes 222 may be considered as certain operational parameters corresponding to the computing device 202. For example, in the context of a print device, the device attributes 222 may include toner level, drum condition, fuser condition, counts of the page printed, and the like.

At block 420, the diagnostic tests are determined corresponding to the device attributes. For example, the diagnostic engine 214 selects the appropriate diagnostic tests 224 corresponding to the device attributes 222. In an example, the diagnostic tests 224 may be selected based on certain predefined rules.

At block 422, the diagnostic tests 224 may be executed. For example, the diagnostic engine 214 may execute the diagnostic tests 224 on the computing device 202. The execution of the diagnostic tests 224, in one example, yields values of the device attributes 222. In an example, the values of the device attributes 222 may be stored as diagnostic information 226.

At block 424, the diagnostic information may be further processed to provide a service operation to be performed for servicing the computing device. For example, the servicing agent 104 may identify a servicing operation 228 based on the diagnostic information 226. The servicing operation 228 may include a series of corrective operations that may be performed by the user for servicing the computing device 202. In an example, the servicing operation 228 may either be executed manually or maybe enabled through the execution of predefined executable code.

At block 426, the servicing operations may be implemented for servicing the computing device 202. For example, the servicing operation 228 provided by the servicing agent 104 may include a series of corrective operations to be performed by the user. Such operations may be performed for the computing device 202 to resolve the operational issue being faced.

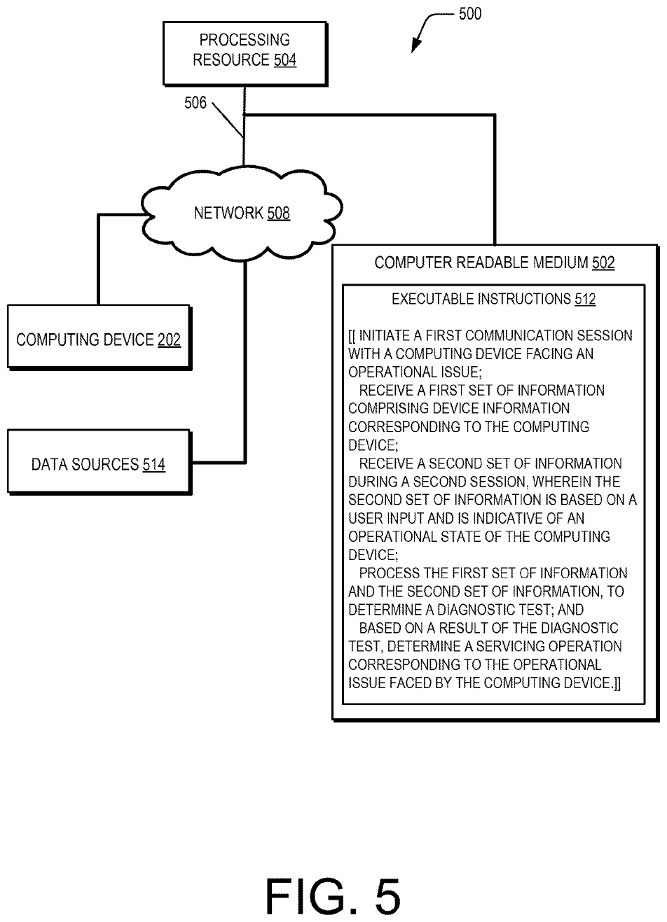

FIG. 5 illustrates a computing environment 500 implementing a non-transitory computer-readable medium 502 for servicing of a computing device, as per an example. In an example, the computing environment 500 may comprise the above-explained computing device 202. The computing environment 500 includes a processing resource 504 communicatively coupled to the non-transitory computer-readable medium 502 through a communication link 506. In an example, the processing resource 504 may be a processor of the system 102 that fetches and executes computer-readable instructions from the non-transitory computer-readable medium 502.

The non-transitory computer-readable medium 502 may be, for example, an internal memory device or an external memory device. In an example, the communication link 506 may be a direct communication link, such as any memory read/write interface. In another example, the communication link 506 may be an indirect communication link, such as a network interface. In such a case, the processing resource 504 may access the non-transitory computer-readable medium 502 through a network 508. The network 508 may be a single network or a combination of multiple networks and may use a variety of different communication protocols.

The processing resource 504 and the non-transitory computer-readable medium 502 may also be communicatively coupled to data sources 510. The data source(s) 510 may be used to store information, such as, device information, user input, device attributes, diagnostic tests, diagnostic information, service operations, and so forth. In an example, the non-transitory computer-readable medium 502 comprises executable instructions 512 for servicing a computing device 202. For example, the non-transitory computer-readable medium 502 may comprise executable instructions 512 to implement the previously described servicing agent 104 and diagnostic test module 206.

In an example, the instructions 512 may cause the processing resource 504 to initiate a first session between the system 102 and the computing device 202. In an example, the first session may be initiated by a user of the computing device 202 facing an operational issue. Further, the processing resource 504 may receive a first set of information during the first session. In an example, the first set of information corresponds to device information corresponding to the computing device 202. Further, the instructions 512 may cause the processing resource 504 to receive a second set of information during a second session. The second set of information is based on a user input and is indicative of an operational state of the computing device. In an example, the second session is implemented as a voice call from a user of the computing device 202, via a user device such as the user device 204.

Thereafter, the instructions 512 may cause the processing resource 504 to process the first set of information and the second set of information to determine diagnostic tests for the computing device 202. For example, the instructions 512 may cause the processing of the device information 218 and the user input 220 to determine diagnostic tests 224. In an example, the servicing agent 104 may initially determine an intent based on the user input 220. The intent and the device information 218 may be further analyzed to determine device attributes 222 pertaining to the computing device 202. Based on the device attributes 222, the diagnostic engine 214 may identify appropriate diagnostic tests 224.

Furthermore, the instructions 512 may cause the processing resource 504 to implement the diagnostic test on the computing device 202. In an example, the diagnostic test is executed on the computing device 202 to derive diagnostic information relating to device attributes, therefrom. Continuing further, a servicing operation is determined based on a result of the diagnostic test corresponding to the operational issue faced by the computing device. In an example, such servicing operation may resolve the operational issue faced by the computing device. In another example, the servicing operation may invoke an external platform to partially or completely resolve the operational issue.

Although examples for the present disclosure have been described in language specific to structural features and/or methods, it is to be understood that the appended claims are not necessarily limited to the specific features or methods described. Rather, the specific features and methods are disclosed and explained as examples of the present disclosure.

We claim:

1. A system comprising:
a servicing agent to:
receive a first set of information from a computing device during a first session, wherein the first set of information comprises device information corresponding to the computing device;
receive a second set of information during a second session, wherein the second set of information is received through a user input and is indicative of a state of the computing device;
process the first set of information and the second set of information to determine a diagnostic test; and
cause to execute the diagnostic test for the computing device.

2. The system as claimed in claim 1, wherein the servicing agent is to:
generate a first session identifier for the first session and a second session identifier for the second session; and
link the first session and the second session based on the first session identifier and the second session identifier.

3. The system as claimed in claim 1, wherein the servicing agent, to process the first set of information and the second set of information, is to:
obtain a set of predetermined criteria;
analyze the first set of information and the second set of information based on the predetermined criteria; and
derive a device attribute to be obtained from the computing device.

4. The system as claimed in claim 3, wherein the device attribute obtained from the computing device is based on the execution of the diagnostic test.

5. The system as claimed in claim 1, wherein the servicing agent is to:
provide a set of intermediate operations in response to the first set of information received from the computing device;
receive an input indicating no change in state of the computing device in response to implementing the set of intermediate operations; and
in response to the received input, initiate the second session with a user of the computing device.

6. The system as claimed in claim 1, wherein the second session is a voice-based communication session.

7. The system as claimed in claim 1, wherein the servicing agent is to identify a servicing operation to be implemented based on the execution of the diagnostic test.

8. The system as claimed in claim 1, wherein the servicing agent is to:
execute the diagnostic test to generate diagnostic information;
communicate additional queries to a user of the computing device;
receiving a further input from the user of the computing device; and
identifying a subsequent diagnostic test based on analysis of the received further input

9. A method comprising:
initiating a first session with a computing device facing an operational issue;
receiving a first set of information comprising device information corresponding to the computing device;
receiving a second set of information during a second session, wherein the second set of information is based on a user input and is indicative of an operational state of the computing device;
processing the first set of information and the second set of information, to determine a diagnostic test;
causing to implement the diagnostic test on the computing device; and
based on a result of the diagnostic test, determining a servicing operation corresponding to the operational issue faced by the computing device.

10. The method as claimed in claim 9, wherein the method comprises
generating a first session identifier for the first session, wherein the first session identifier is associated with an active time duration; and
allocating a communication resource for the second session, during the active time duration of the first session identifier.

11. The method as claimed in claim 9, wherein the method comprises invoking an external platform to execute the servicing operation corresponding to the operational issue faced by the computing device.

12. The method as claimed in claim 9, wherein the method comprises:
providing a set of intermediate operation in response to the first set of information received from the computing device;
receiving an input indicating no change in state of the computing device in response to implementing the set of intermediate operations; and
in response to the received input, initiating the second session with a user of the computing device.

13. A non-transitory computer-readable medium comprising instructions executable by a processing resource to:
initiate a first session with a computing device facing an operational issue;
receive a first set of information comprising device information corresponding to the computing device;
receive a second set of information during a second session, wherein the second set of information is based on a user input and is indicative of an operational state of the computing device;
process the first set of information and the second set of information, to determine a diagnostic test;
cause to implement the diagnostic test on the computing device; and
based on a result of the diagnostic test, determine a servicing operation corresponding to the operational issue faced by the computing device.

14. The non-transitory computer-readable medium as claimed in claim 13, further comprising instructions executable by processing resource to:
provide a set of intermediate operations in response to the first set of information received from the computing device;
receive an input indicating no change in state of the computing device, in response to implementing the set of intermediate operations; and
in response to the received input, initiate the second session with a user of the computing device.

15. The non-transitory computer-readable medium as claimed in claim 14, further comprising instructions executable by processing resource to:
in addition to processing the first set of information and the second set of information, to determine the diagnostic test
communicate the diagnostic test to a user during the second session as one of: voice-based response and electronic message transmitted to a user device.
